(19) United States
(12) Patent Application Publication
(10) Pub. No.: US 2023/0329498 A1
(43) Pub. Date: Oct. 19, 2023

(54) SMALL PARTICLE REMOVING MODULE FOR VACCUM CLEANERS

(71) Applicant: Jiajiu SHAW, Frisco, TX (US)

(72) Inventor: Jiajiu SHAW, Frisco, TX (US)

(21) Appl. No.: 17/719,713

(22) Filed: Apr. 13, 2022

(51) Int. Cl. A47L 9/16; A47L 9/10; A47L 9/24; B04C 3/00

(52) U.S. Cl. CPC A47L 9/1683; A47L 9/102; A47L 9/248; B04C 3/00

(57) ABSTRACT

A small particle removal module that comprises a length of tube having at least one helix shaped portion between opposite ends of the length of tube. The small particle removal module is designed to be attached to the inlet of a vacuum machine and used to vacuum-clean areas. Small particles that are drawn into the small particle removal module by the airflow created by the vacuum machine impact the inner surface of the length of tube. An adhesive coating provided on the inner surface of the length of tube particularly at the at least one helix shaped portion aids in capturing the small particles upstream of the vacuum machine.

### BACKGROUND

The present invention relates generally to vacuum cleaners and more particularly relates to modules that can be used in conjunction with vacuum cleaners which modules trap small particles that may otherwise pass through and be released during vacuuming procedures.

Most everyone has some experience in using a vacuum cleaner, whether it's a vacuum cleaner using a paper bag or a bagless vacuum cleaner using a HEPA filter and dust bin. Although vacuum cleaners are very useful in cleaning, today's vacuum cleaners are associated with some issues that are not desirable. Examples include bad odors and/or unhealthful microorganisms being released by vacuum cleaners, emptying debris from dust bins, and/or changing capture bags, and replacing HEPA filters.

Unpleasant odors associated with dust, molds, bacteria and fungi can be collected or accumulated inside vacuum cleaners and released during use. For vacuums that include HEPA filters, the release of unpleasant odors may be reduced somewhat, but not completely. In general HEPA filters can remove about 99.97% of dust, pollen, mold, bacteria, and any airborne particles that have a size of 0.3 microns or larger. However, some smaller particles or bad odors will go through HEPA filters. For example, sulfur with an approximate molecule diameter of 0.0004 μm is detectable by smell and could certainly pass through HEPA filters

Emptying the debris from dust bins/collectors can be unpleasant and unhealthful when the emptying process creates a plume of dust particles. Likewise emptying debris from bag-less vacuum cleaners can also create plumes of dust particles due to such small particles passing into the vacuum cleaners. Such dust particle plumes are both unpleasant and unhealthy.

The need to frequently replace the HEPA filters in vacuum cleaners can be costly. For vacuum cleaners using HEPA filters, the filters get dirty quite easily. If the filter is not replaced timely, the vacuum efficiency can be greatly reduced. Therefore, HEPA filters need to be replaced periodically adding to the cost of using vacuum cleaners with HEPA filters.

The present invention provides small particle removing modules that can be used in conjunction with vacuum cleaners which modules trap small particles that may otherwise pass through and be released during vacuuming procedures.

### BRIEF SUMMARY

According to various features, characteristics and embodiments of the present invention which will become apparent as the description thereof proceeds, the present invention provides a small particle removal module in combination with a vacuum cleaner, said vacuum cleaner including an inlet and said small particle removal module comprising:
a length of tube having an inlet on one end and an outlet on an opposite end, and at least one helix shaped configuration between said inlet and said outlet,
wherein at least one of said inlet and said outlet being configured to be attached to the inlet of the vacuum cleaner.

The present invention further provides a small particle removal module that comprises:
a length of tube having an inlet on one end and an outlet on an opposite end;
at least one helix shaped configuration between said inlet and said outlet; and
an adhesive coating on an inner surface of the length of tube

The present invention further provides a method of vacuuming an area which comprises:
providing a vacuum machine that has an inlet;
providing a small particle removal module that comprises a length of tube having an inlet on one end and an outlet on an opposite end, and at least one helix shaped configuration between said inlet and said outlet;
attaching one of the inlet or outlet of the small particle removal module to the inlet of the vacuum machine; and
using the small particle removal module to vacuum an area.

### BRIEF DESCRIPTION OF THE DRAWINGS

The present invention will be described with reference to the attached drawings which are given as non-limiting examples only, in which:

FIG. 1 is a perspective view of a small particle removing module according to one embodiment of the present invention.

FIG. 2 is a perspective view of a small particle removing module according to another embodiment of the present invention.

FIG. 3 is a perspective view of a small particle removing module according to another embodiment of the present invention.

FIG. 4 is an end view of section of tubing that includes slanted blades according to one embodiment of the present invention.

FIG. 5 is a side view of the section of tubing of FIG. 4.

### DETAILED DESCRIPTION OF THE DRAWINGS AND THE PRESENTLY PREFERRED EMBODIMENTS

As noted above, the present invention provides small particle removing modules that can be used in conjunction with vacuum cleaners which small particle removing modules trap small particles that may otherwise pass through and be released during vacuuming procedures.

The small particle removal modules of the present invention are easily detachable/replaceable modules that are designed to improve the efficiency of vacuum cleaners. Vacuum cleaners to which the small particle removal modules are applicable include household vacuums, shop vacuums, or other machines that use airflow to filter unwanted particles in the air.

The small particle removal modules of the present invention comprise a body with an inlet and outlet, wherein the body is a tube having a helix shaped portion (with one or a multiple of turns or loops), wherein the inlet and outlet have suitable lengths and diameters so that each can couple to and fit snuggly with the inlet of currently available vacuum cleaners, by pushing-in, push-and-turn to lock, screwing, or other commonly known mechanism. Here it is noted that in embodiments of the present invention the small particle removal modules can be attached at either their inlets or outlets to a vacuum cleaner for use, while the other end can be coupled to conventional vacuum cleaner tools as desired.

The small particle removal modules can be made of commonly available material including plastic, paper, metal, or composite material.

FIG. 1 is a perspective view of a small particle removing module according to one embodiment of the present invention.

The small particle removal modules of the present invention generally have tubular configurations with an inlet, outlet and a helix configuration between the inlet and outlet. In FIG. 1 the small particle removal module 1 has a single loop helix configuration 2 between the inlet 3 and outlet 4. When the outlet is connected to the inlet of a vacuum cleaner, particles that are draw into the inlet 3 by the vacuum created by the vacuum cleaner are accelerated in the airflow through the small particle removal module and impact against the inner wall of the small particle removal module in the area of the helix configuration 2. In this regard, the shape of the helix configuration creates an inner wall surface to which the small particles are directed by the airflow and by centrifugal forces acting on small particles that travel in a circular path through the helix configuration 2.

The small particle removal module 1 is shown in FIG. 1 with optional adaptor fittings 5 and 6 that can be provided as desired to connect the outlet 4 of the small particle removal module 1 to the inlet of a vacuum cleaner and the inlet of the small particle removal module to a conventional vacuum tool such as a crevice tool, upholstery tool, floor tool, etc.

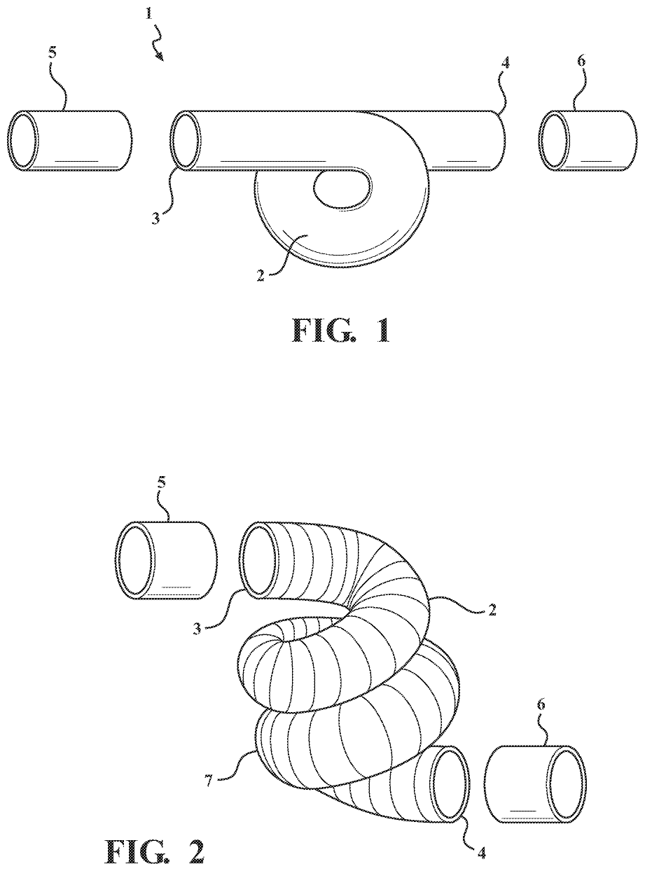

FIG. 2 is a perspective view of a small particle removing module according to another embodiment of the present invention.

The small particle removal module 7 of FIG. 2 includes and inlet 3, outlet 4 and a helix configuration 2 that comprises a plurality of loops.

FIG. 3 is a perspective view of a small particle removing module according to another embodiment of the present invention.

The small particle removal module 8 of FIG. 3 includes a central tubular structure that is divided into separate flow paths. Each flow path includes a helical loop 2a, 2c, and the inlet 3 and outlet 4 are divided into separate flow paths as shown.

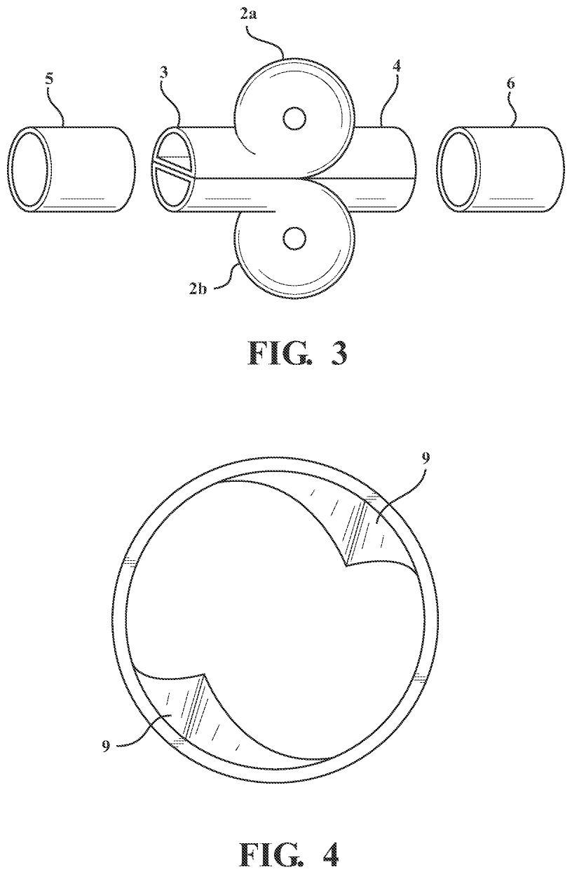

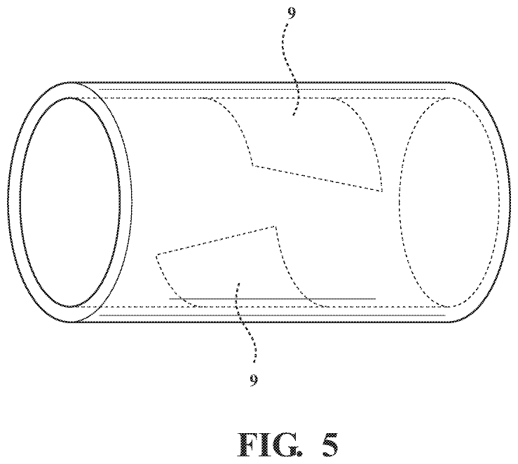

FIG. 4 is an end view of a section of tubing that includes slanted blades according to one embodiment of the present invention. FIG. 5 is a side view of the section of tubing of FIG. 4.

FIGS. 4 and 5 are examples of an alternative or additional way to cause small particles to impact the inner surfaces of a small particle removal module according to the present invention. In FIGS. 4 and 5 the inside of a tubular section is provided with slanted blades 9 that direct airflow through the tubular section toward inner sides of the tubular section, so that small particles entrained in the airflow impact the inner surfaces of the tubular section.

In addition to slanted blades 9 other shaped structures can be provided that that create a vortex or turbulence of air or otherwise direct small particles toward the inner surfaces so as to increase the number of small particles impact the inner surfaces.

While sections or multiples sections of tubing as shown or similar to that of FIGS. 4 and 5 can be used to remove small particles according to the present invention, the sections or multiples sections of tubing as shown or similar to that of FIGS. 4 and 5 can be incorporated into small particle removal modules having helix configurations according to the present invention, including providing such sections at or near the inlets or before the helix configurations of small particle removal modules having helix configurations.

The small particle removal modules can be used with various types of vacuums including conventional household vacuums, shop vacuums and others that include vacuum inlets to which the small particle removal modules can be coupled.

The inlets and outlets of the of the small particle removal modules can have cylindrical or other cross-sectional shapes and lengths that are sufficient so that they can be coupled to the inlets of currently available vacuum cleaners and any desired vacuum tool noted above. The outlets of the small particle removal modules can be coupled to the inlets of vacuums by interference fit, twist-lock, threaded coupling, spring pin engagement or other conventional connection mechanisms.

The small particle removal modules of the present invention can be made of various materials including plastics, papers, metals, or composite materials. The length of tube or tubular section of the small particle removal modules is rigid to the extent that the shape of the helix shaped configured portion is not distortable during use and is not flexible as in the case of hoses that are used with vacuum cleaning machines.

In embodiments of the small particle removal modules that include helix configuration sections one, two or more loops can be included to increase the numbers of small particles that are directed to and impact the internal walls of the modules.

The inner surfaces of the small particle removal modules may be ribbed, corrugated, or roughened in any manner so as to increase the contact surface area making it more easy for small particles to impact internal surface of the small particle removal modules.

A suitable adhesive, especially one with good tackiness, may be coated on the inside of small particle removal modules especially in the helix configuration area. Such an adhesive will aid in capturing small particles that impact the inner surface and prevent the small particles from being pulled back into the airflow and passing through a vacuum.

In further embodiments of the present invention different fragrance oils or compositions can be applied to the inner surface of the small particle removal modules, for example by blending such fragrance oils or compositions in an adhesive applied to the inner surfaces or applying the same over the adhesive layers/coatings or other inside areas.

In further embodiments, different disinfecting chemical compositions can be applied to the inner surfaces of the small particle removal modules by blending such disinfecting chemical in an adhesive applied to the inner surfaces or applying the same over the adhesive layers/coatings or other inside areas.

Small particle removal modules that are provided with different fragrance oils or compositions and/or different disinfecting chemicals can be color coded to aid consumers in identifying the different functionality of the small particle removal modules.

At a suitable position of the small particle removal modules can be made of a transparent material or include a transparent window so a user can monitor the module's dust collecting capability. Such a transparent area or window can be provided near a helix configurated area where small particles will collect and accumulate during use. A user can observe the amount of small particles that accumulate and determine when a small particle removal module needs to be replaced.

By configuring the cross-section area of the small particle removal modules so that they have the same or similar cross-sectional area of a vacuum cleaner inlet the air flux passing through the vacuum cleaner should remain unchanged. Therefore, matching and installing the small particle removal modules to vacuum cleaners should not affect the efficiency of the vacuum cleaners.

In situations in which pet hair is likely to be encountered the small particle removal modules can be provided with one or a plurality of linear fabric strips with tiny loops or hooks (preferably made of nylon or polyester) that are adhered on the inside of the module. When in use, the tiny loops or hooks of these fabric strip(s), can catch and retain animal hair and other fibrous materials.

The small particle removal modules of the present invention can be made using currently available industrial technologies/processes. As to applying/coating the adhesive onto the inside surfaces of the small particle removal modules, in one example of coating the inside the module body one can mask off outside and inside areas that are not to be coated and immerse the modules in a suitable adhesive. Alternatively an adhesive can be applied to areas of the inside surfaces by spraying the adhesive on selective areas of the inside surfaces. Once the glue is applied, the module may or may not have to be cooled down, and any making material used can be removed.

The small particle removal modules of the present invention are designed and configured to cause small particles entrained the in airflow to bounce onto the inside surface of the small particle removal modules at or near the helix configuration portions by the physical designs. Providing inner surface that are rough and/or will cause small particles to be captured and prevented to flow through the associated vacuum cleaners. Providing structures that project inwardly from the inner wall surfaces can be used to create vortex or turbulent airflow at or near the inlet or before helix configuration areas to help capture small particles by the modules. As a result, cleaner air is produced, dumping dust bins of associated vacuum cleaners can be more pleasant, HEPA filters do not have to be replaced as often, undesirable odor can be overcome by pleasant fragrances, and unhealthful microorganisms can be reduced. All these advantages can be achieved by the easily detachable/replaceable small particle removal modules of the present invention without decreasing the vacuuming efficiency of vacuum cleaners.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A small particle removal module in combination with a vacuum cleaner, said vacuum cleaner including an inlet and said small particle removal module comprising:
a length of tube having an inlet on one end and an outlet on an opposite end, and at least one helix shaped configuration between said inlet and said outlet,
wherein at least one of said inlet and said outlet being configured to be attached to the inlet of the vacuum cleaner.

2. The combination of claim 1, wherein the length of tube has an adhesive coating on an inner surface thereof.

3. The combination of claim 2, wherein the adhesive coating is provided along the inner surface of the at least one helix shaped configuration.

4. The combination of claim 1, wherein the at least one helix shaped configuration include a single loop.

5. The combination of claim 1, wherein the at least one helix shaped configuration includes a plurality of loops.

6. The combination of claim 1, further comprising at least one structure that projects inwardly from the length of tube to create a vortex or turbulence in air flow through the small particle removal module.

7. The combination of claim 1, wherein the at least one helix shaped configuration comprises more than one helix shaped configuration.

8. The combination of claim 1, further comprising at least one fabric strip adhered to an inner surface of the length of tube, the at least one fabric strip having loops or hooks.

9. A small particle removal module that comprises:
a length of tube having an inlet on one end and an outlet on an opposite end;
at least one helix shaped configuration between said inlet and said outlet; and
an adhesive coating on an inner surface of the length of tube.

10. A small particle removal module according to claim 9, wherein the adhesive coating is provided along the inner surface of the at least one helix shaped configuration.

11. A small particle removal module according to claim 9, wherein the at least one helix shaped configuration includes a single loop.

12. A small particle removal module according to claim 9, wherein the at least one helix shaped configuration includes a plurality of loops.

13. A small particle removal module according to claim 9, further comprising at least one structure that projects inwardly from the length of tube to create a vortex or turbulence in air flow through the small particle removal module

14. A small particle removal module according to claim 8, further comprising at least one fabric strip adhered to an inner surface of the length of tube, the at least one fabric strip having loops or hooks.

15. A method of vacuuming an area which comprises:
providing a vacuum machine that has an inlet;
providing a small particle removal module that comprises a length of tube having an inlet on one end and an outlet on an opposite end, and at least one helix shaped configuration between said inlet and said outlet;
attaching one of the inlet or outlet of the small particle removal module to the inlet of the vacuum machine; and
using the small particle removal module to vacuum an area.

16. A method of vacuuming an area according to claim 15, wherein the length of tube has an adhesive coating on an inner surface thereof.

17. A method of vacuuming an area according to claim 16, wherein the adhesive coating is provided along the inner surface of the at least one helix shaped configuration.

18. A method of vacuuming an area according to claim 15, wherein the at least one helix shaped configuration includes a plurality of loops.

19. A method of vacuuming an area according to claim 15, further comprising at least one structure that projects inwardly from the length of tube to create a vortex or turbulence in air flow through the small particle removal module.

20. A method of vacuuming an area according to claim 15, further comprising at least one fabric strip adhered to an inner surface of the length of tube, the at least one fabric strip having loops or hooks.
